(19) United States
(12) Patent Application Publication
(10) Pub. No.: US 2020/0362090 A1
(43) Pub. Date: Nov. 19, 2020

(54) METHOD FOR PRODUCING POLYURETHANE POLYMERS WITH REDUCED HEAT VALUE

(71) Applicant: Covestro Deutschland AG, Leverkusen (DE)

(72) Inventors: Christoph GÜRTLER, Köln (DE); Volker MARKER, Burscheid (DE); Thomas Ernst MÜLLER, Aachen (DE); Matthias LEVEN, Köln (DE); Claudia BIZZARRI, Karlsruhe (DE); Walter LEITNER, Aachen (DE)

(21) Appl. No.: 16/326,475

(22) PCT Filed: Aug. 23, 2017
(86) PCT No.: PCT/EP2017/071219

§ 371 Date: Feb. 19, 2019

(30) Foreign Application Priority Data
Aug. 25, 2016 (EP) 16185744.6

(51) Int. Cl. C08G 18/75; C08G 18/56; C08G 18/76

(52) U.S. Cl. CPC C08G 18/758; C08G 2101/0083; C08G 18/7621; C08G 18/56

(57) ABSTRACT

The invention relates to a method for producing a polyurethane polymer, comprising the step of reacting a polyol component with a polyisocyanate component, the polyol component comprising an oxymethylene polyol. The ratio of the polyol component to the polyisocyanate component is selected such that the polyurethane polymer obtained by the reaction has a content of oxymethylene groups from the oxymethylene polyol of ≥11 wt. % to ≤50 wt. %, preferably ≥11 wt. % to ≤45 wt. %, and the content of oxymethylene groups from the oxymethylene polyol is defined by means of proton resonance spectroscopy.

### CROSS-REFERENCE TO RELATED APPLICATION

The present application is a national stage application under 35 U.S.C. § 371 of PCT/EP2017/071219, filed Aug. 23, 2017, which claims the benefit of European Application No. 16185744.6, filed Aug. 25, 2016, both of which are being incorporated by reference herein.

### FIELD

The present invention relates to a process for preparing a polyurethane polymer, comprising the step of reacting a polyol component with a polyisocyanate component, wherein the polyol component comprises an oxymethylene polyol, wherein the quantitative ratio of the polyol component to the polyisocyanate component is chosen such that the polyurethane polymer obtained by the reaction has a particular content of oxymethylene groups originating from the oxymethylene polyol.

At the present time, more than 11 million tonnes of polyurethane per annum are produced globally. From the aspect of a more sustainable manner of production, the use of polyols originating at least partly from renewable raw material sources is desirable. A possible C₁ unit is especially formaldehyde. Formaldehyde is not tied to the availability of mineral oil and is readily obtainable in large volumes. An important field of use for formaldehyde is the preparation of polymeric materials based on oxymethylene (OM).

WO 2014/095679 A1 describes a process for preparing NCO-modified oxymethylene block copolymers, comprising the step of polymerizing formaldehyde in the presence of a catalyst, wherein the polymerization of formaldehyde is additionally effected in the presence of a starter compound having at least 2 Zerewitinoff-active hydrogen atoms, giving an intermediate, and the resultant intermediate is reacted with an isocyanate to give an NCO-modified oxymethylene copolymer. Polyisocyanates are mentioned as possible reagents for NCO modification. However, the examples in this patent application disclose merely tolyl isocyanate, a monoisocyanate. The production of polyurethanes is not demonstrated; the effect on the properties of polyurethanes is likewise not described.

EP 0 004 618 A1 relates to a process for producing sparingly flammable flexible polyurethane foams by reaction of aromatic polyisocyanates, polyols, flame retardants and blowing agents, and optionally chain extenders and additives, characterized in that the aromatic polyisocyanates used are a mixture of diphenylmethane diisocyanates and polyphenyl polymethylene polyisocyanates having a content of diphenylmethane diisocyanates of 40% to 90% by weight, based on the total weight, the flame retardants used are cyanic acid derivatives, and the blowing agent used is water. One flame-retardant cyanic acid derivative disclosed is melamine.

Conventional polyurethanes have comparatively high calorific values and thus constitute considerable fire loads. According to the prior art, additives that inhibit flammability are used for fire protection. These additions are limited in terms of their usable scope and in terms of efficacy. Many of the substances used for this purpose additionally come with toxic properties that can restrict the permissible use range.

### SUMMARY

It is an object of the present invention to provide a polyurethane polymer in which the calorific value has been reduced via the fundamental construction of the polymer structure. Advantageously, the preparation of the polyurethane polymer should be based on a non-mineral oil-based C₁ unit. Formaldehyde is such a C₁ unit that should be made available in the context of the present invention as a unit for the production of polyurethane materials having low calorific value.

This object is achieved in accordance with the invention by a process for preparing a polyurethane polymer, comprising the step of reacting a polyol component with a polyisocyanate component, where the polyol component comprises an oxymethylene polyol, wherein the quantitative ratio of the polyol component to the polyisocyanate component is chosen such that the polyurethane polymer obtained by the reaction has a content of oxymethylene groups originating from the oxymethylene polyol of ≥11% by weight to ≤50% by weight, preferably of ≥11% by weight to ≤45% by weight, and the content of oxymethylene groups originating from the oxymethylene polyol has been determined by means of proton resonance spectroscopy.

The polyurethanes prepared according to the present invention have a lower calorific value than comparable polyurethanes wherein the polyol component does not contain any oxymethylene groups. It is possible to produce moldings or foams that find use in fire protection of buildings or in other sensitive sectors such as passenger transportation. The reduction in the calorific value can be achieved here without the addition of additives that affect the material properties. The calorific value should be understood here to mean the calorific value to DIN 51900, expressed in kJ/kg.

### DETAILED DESCRIPTION

In the context of the present invention, oxymethylene polyols are understood to mean both oxymethylene polyols having one oxymethylene unit and polyoxymethylene polyols having at least two oxymethylene units in direct succession.

The composition of the polyol component is chosen such that the polyurethane has a content of oxymethylene groups originating from the oxymethylene polyol of ≥11% by weight. A preferred content is from ≥11% by weight to ≤50% by weight, more preferably from ≥11% by weight to ≤45% by weight, most preferably ≥20% by weight to ≤45% by weight.

The polyol component may include further polyols. In that case, the content of the oxymethylene polyol in the polyol component and the content of oxymethylene groups in the oxymethylene polyol are chosen so as to comply with the total content of oxymethylene groups required in accordance with the invention in the polyurethane.

Oxymethylene polyols in the context of the present invention refer to oligomeric compounds that contain oxymethylene groups and have at least 1.8, preferably 1.9 and more preferably two hydroxyl groups.

An oxymethylene group in the context of the invention comprises at least one oxymethylene unit and preferably 2 to 20 or preferably at most 150 oxymethylene units.

The polyisocyanate component may especially comprise an aliphatic or aromatic di- or polyisocyanate. Examples are butylene 1,4-diisocyanate, pentane 1,5-diisocyanate, hexamethylene 1,6-diisocyanate (HDI) or the dimers, trimers, pentamers, heptamers or nonamers thereof or mixtures thereof, isophorone diisocyanate (IPDI), 2,2,4- and/or 2,4,4-trimethylhexamethylene diisocyanate, the isomeric bis(4,4′-isocyanatocyclohexyl)methanes or mixtures thereof with any isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and alkyl 2,6-diisocyanatohexanoates (lysine diisocyanates) having C₁ to C₆-alkyl groups. Preference is given here to an isocyanate from the diphenylmethane diisocyanate series.

In addition to the abovementioned polyisocyanates, it is also possible to use proportions of modified diisocyanates of uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

The isocyanate may be a prepolymer obtainable by reacting an isocyanate having an NCO functionality of ≥2 and polyols having a molecular weight of ≥62 g/mol to ≤8000 g/mol and OH functionalities of ≥1.5 to ≤6.

Embodiments and further aspects of the present invention are outlined hereinafter. They can be combined with one another as desired unless the opposite is apparent from the context.

In one embodiment of the process, the polyol component comprises an oxymethylene polyol A) and/or B) obtainable by:

in the case of the oxymethylene polyol A)
reacting formaldehyde with a starter compound having at least 2 Zerewitinoff-active hydrogen atoms and comonomers in the presence of a catalyst;
   in the case of the oxymethylene polyol B)
reacting an oligomeric formaldehyde precursor with a starter compound having at least 2 Zerewitinoff-active hydrogen atoms in the presence of a catalyst.

In the case of the oxymethylene polyol A), the comonomer is preferably an alkylene oxide, more preferably ethylene oxide, propylene oxide and/or styrene oxide.

With regard to the formaldehyde in the preparation of oxymethylene polyol A), it should be noted that formaldehyde can be used in the gaseous state, optionally as a mixture with inert gases, for example nitrogen or argon, or in the form of a mixture with gaseous, supercritical or liquid carbon dioxide, or in the form of formaldehyde solution. Formaldehyde solutions may be aqueous formaldehyde solutions having a formaldehyde content between 1% by weight and 37% by weight, which may optionally contain up to 15% by weight of methanol as stabilizer. Alternatively, it is possible to use solutions of formaldehyde in polar organic solvents, for example methanol or higher mono- or polyhydric alcohols, 1,4-dioxane, acetonitrile, N,N-dimethylformamide (DMF), N,N-dimethylacetamide, dimethyl sulfoxide (DMSO), cyclic carbonates, e.g. ethylene carbonate or propylene carbonate, N-methylpyrrolidone (NMP), sulfolane, tetramethylurea, N,N′-dimethylethyleneurea or mixtures thereof with one another, or with water and/or other solvents. The presence of further substances in solution is likewise included as well. Preference is given to the use of mixtures of gaseous formaldehyde with argon or carbon dioxide. Likewise preferred is the use of solutions of formaldehyde in aprotic polar organic solvents, for example 1,4-dioxane, acetonitrile, N,N-dimethylformamide (DMF), N,N-dimethylacetamide, dimethyl sulfoxide (DMSO), cyclic carbonates, e.g. ethylene carbonate or propylene carbonate, N-methylpyrrolidone (NMP), sulfolane, tetramethylurea, N,N′-dimethylethyleneurea or mixtures thereof with one another and/or other solvents.

Alternatively, formaldehyde can be generated in situ from a suitable formaldehyde source. Formaldehyde sources used may be substances which contain chemically bound formaldehyde, typically in the form of oxymethylene groups, and are capable of releasing formaldehyde under suitable conditions. Suitable conditions for the release may include, for example, elevated temperatures and/or the use of catalysts and/or the presence of acids, bases or other reagents which lead to the release of monomeric formaldehyde. Preferred formaldehyde sources are 1,3,5-trioxane, paraformaldehyde, polyoxymethylene, dimethyl acetal, 1,3-dioxolane, 1,3-dioxane and/or 1,3-dioxepane, particular preference being given to 1,3,5-trioxane and paraformaldehyde.

With regard to the oligomeric formaldehyde precursor in the preparation of oxymethylene polyol B), it should be noted that formaldehyde sources used may be substances which contain chemically bound formaldehyde, typically in the form of oxymethylene groups, and are capable of releasing formaldehyde under suitable conditions. Suitable conditions for the release may include, for example, elevated temperatures and/or the use of catalysts and/or the presence of acids, bases or other reagents which lead to the release of monomeric formaldehyde. Preferred formaldehyde sources are 1,3,5-trioxane, dimethyl acetal, 1,3-dioxolane, 1,3-dioxane and/or 1,3-dioxepane.

Polymeric formaldehyde starter compounds suitable for the process of the invention generally have molar masses of 62 to 30 000 g/mol, preferably of 62 to 12 000 g/mol, more preferably of 242 to 6000 g/mol and most preferably of 242 to 3000 g/mol, and comprise from 2 to 1000, preferably from 2 to 400, more preferably from 8 to 200 and most preferably from 8 to 100 repeat oxymethylene units. The starter compounds used in the process of the invention typically have a functionality (F) of 1 to 3, but in particular cases may also be of higher functionality, i.e. have a functionality of >3. Preference is given to using, in the process of the invention, open-chain polymeric formaldehyde starter compounds having terminal hydroxyl groups and having a functionality of 1 to 10, preferably of 1 to 5, more preferably of 1.8 to 3. Very particular preference is given to using, in the process of the invention, linear polymeric formaldehyde starter compounds having a functionality of 1.8 (e.g. GRANUFORM® from Ineos). The functionality F corresponds to the number of OH end groups per molecule.

With regard to the starter compound in the preparation of oxymethylene polyol A) and oxymethylene polyol B), it should be noted that these are preferably bifunctional or higher-functionality compounds having a number-average molecular weight Mₙ of, for example, between 100 and 3000 g/mol. The functionality is established via deprotonatable functional groups which contain heteroatoms and are terminal or arranged along the polymer chain, for example hydroxyl groups, thiol groups, amino groups, carboxylic acid groups or carboxylic acid derivatives, for example amides. Hydrogen bonded to N, O or S is referred to as Zerewitinoff-active hydrogen (or as “active hydrogen”) when it affords methane by reaction with methylmagnesium iodide, by a method discovered by Zerewitinoff. The starter compounds typically have a functionality of ≥2, for example within a range from ≥2 to ≤6, preferably from ≥2 to ≤4 and more preferably from ≥2 to ≤3.

In a preferred embodiment of the process of the invention, the at least one starter compound is selected from the group consisting of polyether polyols, polyester polyols, polyetherester polyols, polyethercarbonate polyols, polycarbonate polyols and polyacrylate polyols.

The polyols may have, for example, a number-average molecular weight Mₙ of ≥62 g/mol to ≤8000 g/mol, preferably of ≥90 g/mol to ≤5000 g/mol and more preferably of ≥92 g/mol to ≤2000 g/mol.

The average OH functionality of the polyols is ≥1.8, preferably ≥1.9 and more preferably ≥2, for example within a range from ≥2 to ≤6, preferably from ≥2.0 to ≤4 and more preferably from ≥2.0 to ≤3.

Polyether polyols that may be used include, for example, polytetramethylene glycol polyethers as are obtainable by polymerization of tetrahydrofuran by cationic ring opening.

Likewise suitable polyether polyols are addition products of styrene oxide, ethylene oxide, propylene oxide, butylene oxide and/or epichlorohydrin onto di- or polyfunctional starter molecules.

Suitable starter molecules for the polyether polyols are, for example, water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, butane-1,4-diol, hexane-1,6-diol and low molecular weight hydroxyl-containing esters of such polyols with dicarboxylic acids.

Suitable polyester polyols include polycondensates of di- and also tri- and tetraols and di- and also tri- and tetracarboxylic acids or hydroxycarboxylic acids or lactones. Instead of the free polycarboxylic acids, it is also possible to use the corresponding polycarboxylic anhydrides or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate. In addition, it is also possible to use polyols such as trimethylolpropane, glycerol, erythritol, pentaerythritol, trimethylolbenzene or trishydroxyethyl isocyanurate.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as acid source.

If the mean functionality of the polyol to be esterified is >2, it is additionally also possible to use monocarboxylic acids, for example benzoic acid and hexanecarboxylic acid as well.

Examples of hydroxycarboxylic acids that may be used as reaction participants in the preparation of a polyester polyol having terminal hydroxyl groups include hydroxycaproic acid, hydroxybutyric acid, hydroxydecanoic acid, hydroxystearic acid and the like. Suitable lactones include caprolactone, butyrolactone and homologs.

Polycarbonate polyols that may be used are hydroxyl-containing polycarbonates, for example polycarbonate diols. These are obtainable by reaction of carbonic acid derivatives, such as diphenyl carbonate, dimethyl carbonate or phosgene, with polyols, preferably diols.

Examples of such diols are ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A and lactone-modified diols of the abovementioned type.

Usable polyetherester polyols are compounds containing ether groups, ester groups and OH groups. Organic dicarboxylic acids having up to 12 carbon atoms are useful for producing the polyetherester polyols, preferably aliphatic dicarboxylic acids having ≥4 to ≤6 carbon atoms or aromatic dicarboxylic acids used singly or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Derivatives of these acids that may be used include, for example, their anhydrides and also their esters and monoesters with low molecular weight monofunctional alcohols having ≥1 to ≤4 carbon atoms.

A further component used for preparation of the polyether ester polyols is polyether polyols, which are obtained by alkoxylating starter molecules, for example polyhydric alcohols. The starter molecules are at least difunctional, but may optionally also contain proportions of higher-functional, in particular trifunctional, starter molecules.

Starter molecules for these polyether polyols are, for example, diols having number-average molecular weights Mₙ of preferably ≥18 g/mol to ≤400 g/mol or of ≥62 g/mol to ≤200 g/mol, such as ethane-1,2-diol, propane-1,3-diol, propane-1,2-diol, butane-1,4-diol, pentene-1,5-diol, pentane-1,5-diol, neopentyl glycol, hexane-1,6-diol, heptane-1,7-diol, octane-1,8-diol, decane-1,10-diol, 2-methylpropane-1,3-diol, 2,2-dimethylpropane-1,3-diol, 3-methylpentane-1,5-diol, 2-butyl-2-ethylpropane-1,3-diol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomer mixtures of alkylene glycols, such as diethylene glycol.

In addition to the diols, polyols having number-average functionalities of ≥2 to ≤8, or of ≥3 to ≤4 may also be employed, examples being 1,1,1-trimethylolpropane, triethanolamine, glycerol, sorbitan and pentaerythritol and also triol- or tetraol-started polyethylene oxide polyols having average molecular weights of preferably ≥62 g/mol to ≤400 g/mol or of ≥92 g/mol to ≤200 g/mol.

Polyetherester polyols may also be produced by alkoxylation of reaction products obtained by reaction of organic dicarboxylic acids and diols. Derivatives of these acids that may be used include, for example, their anhydrides, for example phthalic anhydride.

Polyacrylate polyols are obtainable by free-radical polymerization of hydroxyl-containing, olefinically unsaturated monomers or by free-radical copolymerization of hydroxyl-containing, olefinically unsaturated monomers with optionally other olefinically unsaturated monomers. Examples thereof include ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Useful hydroxyl-containing, olefinically unsaturated monomers are in particular 2-hydroxyethyl acrylate, 2-hydroxyethyl methacrylate, the hydroxypropyl acrylate isomer mixture obtainable by addition of propylene oxide onto acrylic acid, and the hydroxypropyl methacrylate isomer mixture obtainable by addition of propylene oxide onto methacrylic acid. Terminal hydroxyl groups may also be in protected form. Suitable free-radical initiators are those from the group of the azo compounds, for example azoisobutyronitrile (AIBN), or from the group of the peroxides, for example di-tert-butyl peroxide.

Catalysts are suitable in principle for the preparation of the oxymethylene polyols A) and/or B) are selected from the group of the basic catalysts and/or the Lewis-acidic catalysts. Catalysts used are compounds which catalyze the polymerization of formaldehyde. These may be basic catalysts or Lewis-acidic catalysts containing, as the Lewis-acidic center, for example, a metal of the third, fourth or fifth main group, especially boron, aluminum, tin or bismuth, a metal of the third or fourth transition group or of the lanthanoid series, vanadium, molybdenum, tungsten or a metal of the eighth to tenth transition groups. Preference is given to Lewis-acidic catalysts.

In a further embodiment of the process of the invention, the oxymethylene polyol has a number-average molecular weight of <6000 g/mol, preferably of <4500 g/mol, where the number-average molecular weight has been determined by means of gel permeation chromatography (GPC).

In a further embodiment of the process of the invention, the average hydroxyl functionality of the polyol component is ≥1.8, preferably ≥1.9 and more preferably ≥2.0. The polyurethanes thus obtained have thermoplastic properties owing to their three-dimensional network structure. It is preferable that the average hydroxyl functionality of the polyol component is ≥2.2 to ≤3.5, more preferably ≥2.3 to ≤3.0.

In a further embodiment of the process of the invention, the polyisocyanate component comprises an at least trifunctional polyisocyanate, i.e. a polyisocyanate containing at least three NCO groups in the molecule). The polyurethanes thus obtained have thermoplastic properties owing to their three-dimensional network structure. An example of a useful at least trifunctional polyisocyanate is the trimeric isocyanurate of hexamethylene 1,6-diisocyanate (“HDI trimer”).

In a further embodiment of the process of the invention, the reaction is conducted at an NCO index of ≥90 to ≤200. Preference is given to an index of ≥100 to ≤180.

In a further embodiment of the process of the invention, the polyol component comprises a further polyol, where the at least one further polyol is selected from the group consisting of polyether polyols, polyester polyols, polyetherester polyols, polyethercarbonate polyols, polycarbonate polyols and polyacrylate polyols. The polyols may have, for example, a number-average molecular weight Mₙ of ≥62 g/mol to ≤8000 g/mol, preferably of ≥90 g/mol to ≤5000 g/mol and more preferably of ≥92 g/mol to ≤2000 g/mol.

The average OH functionality of the polyols is ≥1.8, preferably ≥1.9 and more preferably ≥2, for example within a range from ≥2 to ≤6, preferably from ≥2.0 to ≤4 and more preferably from ≥2.0 to ≤3.

Polyether polyols that may be used include, for example, polytetramethylene glycol polyethers as are obtainable by polymerization of tetrahydrofuran by cationic ring opening.

Likewise suitable polyether polyols are addition products of styrene oxide, ethylene oxide, propylene oxide, butylene oxide and/or epichlorohydrin onto di- or polyfunctional starter molecules.

Suitable starter molecules for the polyether polyols are, for example, water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, butane-1,4-diol, hexane-1,6-diol and low molecular weight hydroxyl-containing esters of such polyols with dicarboxylic acids.

Suitable polyester polyols include polycondensates of di- and also tri- and tetraols and di- and also tri- and tetracarboxylic acids or hydroxycarboxylic acids or lactones. Instead of the free polycarboxylic acids, it is also possible to use the corresponding polycarboxylic anhydrides or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate. In addition, it is also possible to use polyols such as trimethylolpropane, glycerol, erythritol, pentaerythritol, trimethylolbenzene or trishydroxyethyl isocyanurate.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as acid source.

If the mean functionality of the polyol to be esterified is >2, it is additionally also possible to use monocarboxylic acids, for example benzoic acid and hexanecarboxylic acid as well.

Examples of hydroxycarboxylic acids that may be used as reaction participants in the preparation of a polyester polyol having terminal hydroxyl groups include hydroxycaproic acid, hydroxybutyric acid, hydroxydecanoic acid, hydroxystearic acid and the like. Suitable lactones include caprolactone, butyrolactone and homologs.

Polycarbonate polyols that may be used are hydroxyl-containing polycarbonates, for example polycarbonate diols. These are obtainable by reaction of carbonic acid derivatives, such as diphenyl carbonate, dimethyl carbonate or phosgene, with polyols, preferably diols.

Examples of such diols are ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A and lactone-modified diols of the abovementioned type.

Usable polyetherester polyols are compounds containing ether groups, ester groups and OH groups. Organic dicarboxylic acids having up to 12 carbon atoms are useful for producing the polyetherester polyols, preferably aliphatic dicarboxylic acids having ≥4 to ≤6 carbon atoms or aromatic dicarboxylic acids used singly or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Derivatives of these acids that may be used include, for example, their anhydrides and also their esters and monoesters with low molecular weight monofunctional alcohols having ≥1 to ≤4 carbon atoms.

A further component used for preparation of the polyetherester polyols is polyether polyols, which are obtained by alkoxylating starter molecules, for example polyhydric alcohols. The starter molecules are at least difunctional, but may optionally also contain proportions of higher-functional, in particular trifunctional, starter molecules.

Starter molecules for these polyether polyols are, for example, diols having number-average molecular weights Mₙ of preferably ≥18 g/mol to ≤400 g/mol or of ≥62 g/mol to ≤200 g/mol, such as ethane-1,2-diol, propane-1,3-diol, propane-1,2-diol, butane-1,4-diol, pentene-1,5-diol, pentane-1,5-diol, neopentyl glycol, hexane-1,6-diol, heptane-1,7-diol, octane-1,8-diol, decane-1,10-diol, 2-methylpropane-1,3-diol, 2,2-dimethylpropane-1,3-diol, 3-methylpentane-1,5-diol, 2-butyl-2-ethylpropane-1,3-diol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomer mixtures of alkylene glycols, such as diethylene glycol.

In addition to the diols, polyols having number-average functionalities of ≥2 to ≤8, or of ≥3 to ≤4 may used well, examples being 1,1,1-trimethylolpropane, triethanolamine, glycerol, sorbitan and pentaerythritol and also triol- or tetraol-started polyethylene oxide polyols having average molecular weights of preferably ≥62 g/mol to ≤400 g/mol or of ≥92 g/mol to ≤200 g/mol.

Polyetherester polyols may also be produced by alkoxylation of reaction products obtained by reaction of organic dicarboxylic acids and diols. Derivatives of these acids that may be used include, for example, their anhydrides, for example phthalic anhydride.

Polyacrylate polyols are obtainable by free-radical polymerization of hydroxyl-containing, olefinically unsaturated monomers or by free-radical copolymerization of hydroxyl-containing, olefinically unsaturated monomers with optionally other olefinically unsaturated monomers. Examples thereof include ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Useful hydroxyl-containing, olefinically unsaturated monomers are in particular 2-hydroxyethyl acrylate, 2-hydroxyethyl methacrylate, the hydroxypropyl acrylate isomer mixture obtainable by addition of propylene oxide onto acrylic acid, and the hydroxypropyl methacrylate isomer mixture obtainable by addition of propylene oxide onto methacrylic acid. Terminal hydroxyl groups may also be in protected form. Suitable free-radical initiators are those from the group of the azo compounds, for example azoisobutyronitrile (AIBN), or from the group of the peroxides, for example di-tert-butyl peroxide.

In the preparation of the oxymethylene polyol, the oxymethylene units are joined to the additional oligomers either directly or indirectly via one or more further comonomers or spacers. It is also possible for a plurality of oxymethylene units to be joined to one another via one or more further comonomers. In a further embodiment of the process of the invention, therefore, in the preparation of the oxymethylene polyol, the polymerization is effected in the presence of a further comonomer. Further comonomers used may, for example, be cyclic ethers, especially epoxides, for example ethylene oxide, propylene oxide or styrene oxide, oxetane, THF, dioxane, cyclic acetals, for example 1,3-dioxolane or 1,3-dioxepane, cyclic esters, for example γ-butyrolactone, γ-valerolactone, ε-caprolactone, or cyclic acid anhydrides, for example maleic anhydride, glutaric anhydride or phthalic anhydride. Preferred further comonomers are epoxides, cyclic acetals and cyclic esters; particularly preferred further comonomers are ethylene oxide, propylene oxide, 1,3-dioxolane, 1,3-dioxepane and ε-caprolactone.

The metered addition of further comonomers can be effected in neat form or in solution. In an alternative embodiment, the metered addition of further comonomers is effected in a mixture with formaldehyde or the formaldehyde source. The metered addition of further comonomers can be effected prior to the metered addition, parallel to the metered addition or after the metered addition of formaldehyde or the formaldehyde source.

In a further preferred embodiment of the process of the invention, the reaction is conducted in the absence of a flame retardant. Flame retardants to be avoided are known in principle to the person skilled in the art and are described, for example, in “Kunststoffhandbuch” [Plastics Handbook], volume 7 “Polyurethane” [Polyurethanes], chapter 6.1. These may, for example, be brominated and chlorinated polyols or phosphorus compounds such as the esters of orthophosphoric acid and of metaphosphoric acid that likewise contain halogen. Especially ruled out in this embodiment are tris(2-chloroisopropyl) phosphate (TCPP), tris(1,3-dichloroisopropyl) phosphate (TDCPP) and tris(2-chloroethyl) phosphate (TCEP).

The present invention further provides a polyurethane polymer obtainable by a process of the invention.

In one embodiment of the polyurethane polymer of the invention, the content of oxymethylene groups is ≥11% by weight. A preferred content is from ≥11% by weight to ≤50% by weight, more preferably from ≥11% by weight to ≤45% by weight, most preferably ≥20% by weight to ≤45% by weight. The content of oxymethylene groups in the polyurethane can most easily be ascertained from the mass balance of formaldehyde in the preparation of the oxymethylene polyol which was used for the preparation of the polyurethane.

In a further embodiment of the polyurethane polymer of the invention, it has a calorific value to DIN 51900 of ≤26 000 kJ/kg. A preferred calorific value is ≤25 000 kJ/kg, more preferably ≤24 500 kJ/kg.

In a further embodiment of the polyurethane polymer of the invention, it does not contain any flame retardant. Flame retardants to be avoided are known in principle to the person skilled in the art and are described, for example, in “Kunststoffhandbuch” [Plastics Handbook], volume 7 “Polyurethane” [Polyurethanes], chapter 6.1. These may, for example, be brominated and chlorinated polyols or phosphorus compounds such as the esters of orthophosphoric acid and of metaphosphoric acid that likewise contain halogen. Especially ruled out in this embodiment are tris(2-chloroisopropyl) phosphate (TCPP), tris(1,3-dichloroisopropyl) phosphate (TDCPP) and tris(2-chloroethyl) phosphate (TCEP).

The present invention further relates to the use of a polyurethane polymer of the invention as insulation material.

In a first version, the invention relates to a process for preparing a polyurethane polymer, comprising the step of reacting a polyol component with a polyisocyanate component, where the polyol component comprises an oxymethylene polyol, wherein the quantitative ratio of the polyol component to the polyisocyanate component is chosen such that the polyurethane polymer obtained by the reaction has a content of oxymethylene groups originating from the oxymethylene polyol of ≥11% by weight to ≤50% by weight, preferably of ≥11% by weight to ≤45% by weight, and the content of oxymethylene groups originating from the oxymethylene polyol has been determined by means of proton resonance spectroscopy.

In a second version, the invention relates to a process according to the first version, wherein the polyol component comprises an oxymethylene polyol A) and/or B) obtainable by:

in the case of the oxymethylene polyol A)
reacting formaldehyde with a starter compound having at least 2 Zerewitinoff-active hydrogen atoms and comonomers in the presence of a catalyst;
   in the case of the oxymethylene polyol B)
reacting an oligomeric formaldehyde precursor with a starter compound having at least 2 Zerewitinoff-active hydrogen atoms in the presence of a catalyst.

In a third version, the invention relates to a process according to the first or second version, wherein the oxymethylene polyol has a number-average molecular weight of <4500 g/mol, wherein the number-average molecular weight has been determined by means of gel permeation chromatography (GPC).

In a fourth version, the invention relates to a process according to the first to third version, wherein, in the preparation of the oxymethylene polyol, at least the one starter compound is selected from the group of the polyether polyols, polyester polyols, polyetherester polyols, polyethercarbonate polyols, polycarbonate polyols and polyacrylate polyols.

In a fifth version, the invention relates to a process according to the first to fourth version, wherein the average hydroxyl functionality of the polyol component is ≥1.8, preferably ≥1.9 and more preferably ≥2.0.

In a sixth version, the invention relates to a process according to the first to fifth version, wherein the polyisocyanate component comprises an at least trifunctional polyisocyanate.

In a seventh version, the invention relates to a process according to the first to sixth version, wherein the reaction is conducted at an NCO index of ≥90 to ≤200.

In an eighth version, the invention relates to a process according to the first to seventh version, wherein the polyol component comprises at least one further polyol selected from the group consisting of polyether polyols, polyester polyols, polyetherester polyols, polyethercarbonate polyols, polycarbonate polyols and polyacrylate polyols.

In a ninth version, the invention relates to a process according to the first to eighth version, wherein, in the preparation of the oxymethylene polyol, the polymerization is effected in the presence of a further comonomer.

In a tenth version, the invention relates to a process according to the first to ninth version, wherein the reaction is conducted in the absence of a flame retardant.

In an eleventh version, the invention relates to a polyurethane polymer obtainable by a process according to the first to tenth version.

In a twelfth version, the invention relates to a polyurethane polymer according to the eleventh version having a content of oxymethylene groups of ≥11% by weight to ≤50% by weight, preferably of ≥11% by weight to ≤45% by weight, and the content of oxymethylene groups originating from the oxymethylene polyol has been determined by means of proton resonance spectroscopy.

In a thirteenth version, the invention relates to a polyurethane polymer according to the eleventh or twelfth version having a calorific value to DIN 51900 of ≤26 000 kJ/kg.

In a fourteenth version, the invention relates to a polyurethane polymer according to any of the eleventh to thirteenth versions not containing flame retardant.

In a fifteenth version, the invention relates to a use of a polyurethane polymer of any of the eleventh to fourteenth versions as insulation material.

The present invention is described in detail by the examples which follow, but without being limited thereto.

### EXAMPLES

### Polyols Used:

Polyol-1: formaldehyde-containing diol obtained from trioxane having a composition (by mass) of 43% propylene oxide, 41% formaldehyde, and 16% ethylene oxide. The number-average molecular weight Mₙ was 5147 g/mol.

Polyol-2: formaldehyde-containing diol obtained from trioxane having a composition (by mass) of 39% propylene oxide, 42% formaldehyde, and 19% ethylene oxide. The number-average molecular weight Mₙ was 7794 g/mol.

Polyol 3: polypropylene glycol having a calorific value to DIN 51900 of 30 440 kJ/kg. The number-average molecular weight Mₙ was 8000 g/mol.

Polyol-4: formaldehyde-containing polyol having a composition (by mass) of 89% propylene oxide and 11% formaldehyde. The number-average molecular weight Mₙ was 1801 g/mol.

Polyol 5: Arcol 1110 Covestro AG 700 g/mol, functionality 3

PFA: Granuform®, Ineos, 94.5-96.5% POM fraction

### Polyisocyanates Used:

Toluene 2,4-diisocyanate: Sigma Aldrich ≥98%

Toluene 2,6-diisocyanate: Sigma Aldrich 97%

Desmodur W: H12-MDI, Covestro AG

### Additives Used:

Melamine: Sigma-Aldrich 99%

### Description of the Methods:

Gel Permeation Chromatography (GPC):

The measurements were effected on an Agilent 1200 Series instrument (G1310A Iso Pump, G1329A ALS, G1316A TCC, G1362A RID, G1365D MWD), detection via RID; eluent: chloroform (GPC grade), flow rate 1.0 ml/min; column combination: PSS SDV precolumn 8×50 mm (5 μm), 2×PSS SDV linear S 8×300 mL (5 μm). Polypropylene glycol samples of known molar mass from “PSS Polymer Standards Service” were used for calibration. The measurement recording and evaluation software used was the “PSS WinGPC Unity” software package. The GPC chromatograms were recorded in accordance with DIN 55672-1.

¹H NMR Spectroscopy:

The measurements were effected on a Bruker AV400 instrument (400 MHz); the chemical shifts were calibrated relative to trimethylsilane as internal standard (8=0.00 ppm) or to the solvent signal (CDCl₃, δ=7.26 ppm); s=singlet, m=multiplet, bs=broad singlet, kb=complex region. The data for the size of the area integrals of the signals were reported relative to one another.

The copolymerization resulted in the oxymethylene polyether polyol which firstly contains oxymethylene units shown in the following formula:

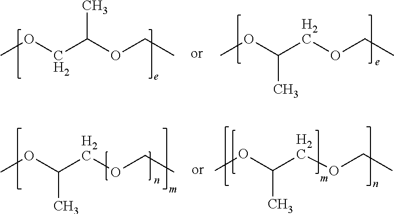

and secondly polyether units shown in the following formula:

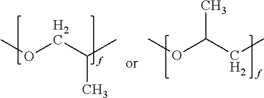

The molar ratio of oxymethylene groups (from formaldehyde) to ether groups in the oxymethylene polyether polyol and the proportion of formaldehyde converted (C in mol %) was determined by means of 1H NMR spectroscopy.

When the copolymerization of formaldehyde and propylene oxide was conducted in the presence of a DMC catalyst, the polyol also contains the polycarbonate units (PEC) shown below:

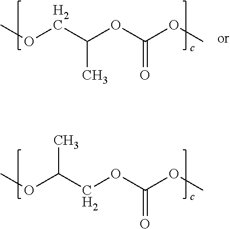

Each sample was dissolved in deuterated chloroform and analyzed on a Bruker spectrometer (AV400, 400 MHz).

The relevant resonances in the ¹H NMR spectrum (based on TMS=0 ppm) which were used for integration are as follows:

I1: 1.11-1.17: methyl group of the polyether units, resonance area corresponds to three hydrogen atoms

I2: 1.25-1.32: methyl group of the polycarbonate units, resonance area corresponds to three hydrogen atoms (when PEC units are present)

I3: 3.093-4.143: CH and CH₂ groups of the polyether units, area of the resonance corresponds to three hydrogen atoms

I4: 4.40-5.20: methyl group of the oxymethylene units, resonance area corresponds to two hydrogen atoms

The molar ratio of oxymethylene groups to ether groups in the oxymethylene polyether polyol and the proportion of propylene oxide converted (C in mol %) are reported.

Taking account of the relative intensities, the relative proportion of the individual structural units i is calculated using the integrals Iᵢ as follows:

n1=I1/3 (PO):

n2=I2/3 (PEC):

n4=I4/2 (CH₂O):

Molar ratio of oxymethylene groups to ether groups in the polymer:

(CH₂O)/(PO)=I4/I1

The molar proportion of the formaldehyde converted (C in mol %) based on the sum total of the amount of propylene oxide used in the activation and the copolymerization is calculated by the formula:

C=[(I4/2)/((I1/3)+(I2/3)+(I3/3)+(I4/2))]*100%

The signals for CH₂O and PEC-CH (when PEC is present) partly overlap. For this reason, all area integrals of these signals are summed and corrected for the PEC-CH fraction.

In the absence of different end groups, for F-functional (where F is 2 for bi-hydroxy-functional polyols, and 3 for trifunctional polyols), oxymethylene polyether copolymers, the average empirical formula can be calculated with the aid of the average molecular weight M.W. ascertained by OH number as follows:

MW=(F×1000×MW_{KOH})/(OH number)

f=MW/Σ((Iᵢ/#Hᵢ)*MWᵢ)

where Iᵢ is the sum total of the integrals of the “i” unit and #H, is the number of protons in unit “i”.

Multiplication of the resulting factor f with the relative proportions (i=PE, PEC, CH₂O) gives the average number x, of the units i in the average empirical formula

((I1/3)×f)−(#PO)ₛₜₐᵣₜₑᵣ #PO:

(I4/2)×f #(CH₂O):

¹³C NMR Spectroscopy:

The measurements were effected on a Bruker AV400 instrument (100 MHz); the chemical shifts were calibrated relative to the solvent signal (CDCl₃, δ=77.16 ppm); APT (attached proton test): CH₂, C_{quart}: positive signal (+); CH, CH₃: negative signal (−); HMBC: Hetero multiple bond correlation; HSQC: Heteronuclear single-quantum correlation.

Thermal data were ascertained by means of DSC (differential scanning calorimetry).

To determine the ignition time, 0.5 g of the substance to be tested was positioned on a metal spatula with a material thickness of 0.5 mm. The material sample was heated with a gas burner at constant power. For this purpose, a homogeneous distance of the burner nozzle of 5.0 cm from the sample was maintained. The duration of the exposure before the ignition of the sample was measured with the aid of a stopwatch and averaged from double determinations.

There follows a description of the performance of the polymerization mentioned by selected examples.

### Example 1: Preparation of a Polyurethane with an Oxymethylene Polyol

Under protective gas (argon), 21 g (4.080 mmol, 1 eq.) of polyol-1 were dissolved in 120 mL of absolute 1,2-dichlorobenzene. 26 mg (0.041 mmol, 0.01 eq.) of dibutyltin dilaurate (DBTL) were added as catalyst and the mixture was heated to 80° C. Under in situ observation by means of infrared spectroscopy, toluene 2,4-diisocyanate was added in small portions until there was no further visible conversion of diisocyanate (1.054 g, 0.605 mmol, 1.48 eq.) over the course of 4 h. The reaction mixture was stirred at a temperature of 80° C. with stirring for a further 10 h and then the polymer formed was separated out by precipitation with n-pentane.

Yield: 15.7 g; 71%.

The data ascertained in the characterization of the polyurethane are compiled in the table below.

| Content of oxymethylene units | 41% by weight | |
|---|---|---|
| Content of polypropylene oxide units | 43% by weight | |
| Content of polyethylene oxide units | 12% by weight | |
| Content of toluene 2,4-diisocyanate units | 3% by weight | |
| Molecular weight Mₙ | 26 265 | g/mol |
| Polydispersity index | 2.2 | |
| Thermal breakdown | 220° C. | |
| Melting point | 160° C. | |
| Enthalpy of fusion | 3.4 | J/g |
| Calorific value to DIN 51900 | 23 527 | kJ/kg |
| Ignition time | 6.6 | s |

### Example 2: Preparation of a Polyurethane with an Oxymethylene Polyol

Under protective gas (argon), 14 g (1.796 mmol, 1 eq.) of polyol-2 were dissolved in 40 mL of absolute 1,2-dichlorobenzene. 12 mg (0.018 mmol, 0.01 eq.) of dibutyltin dilaurate (DBTL) were added as catalyst and the mixture was heated to 80° C. Toluene 2,4-diisocyanate (0.460 g, 0.266 mmol, 1.48 eq.) was added in three portions of equal size over a period of 6 hours. The reaction mixture was stirred at a temperature of 80° C. with stirring for a further 10 h and then the polymer formed was separated out by precipitation with n-pentane.

Yield: 11.4 g; 79%.

The data ascertained in the characterization of the polyurethane are compiled in the table below.

| Content of oxymethylene units | 41% by weight | |
|---|---|---|
| Content of polypropylene oxide units | 37% by weight | |
| Content of polyethylene oxide units | 18% by weight | |
| Content of toluene 2,4-diisocyanate units | 3% by weight | |
| Molecular weight Mₙ | 12 080 | g/mol |
| Polydispersity index | 2.9 | |
| Thermal breakdown | 211° C. | |
| Melting point | 78° C. | |
| Enthalpy of fusion | 17.1 | J/g |
| Calorific value to DIN 51900 | 23 930 | kJ/kg |
| Ignition time | 12.5 | s |

### Example 3: Preparation of a Polyurethane with an Oxymethylene Polyol

Under protective gas (argon), 7 g (0.898 mmol, 1 eq.) of polyol-2 were dissolved in 30 mL of absolute 1,2-dichlorobenzene. 6 mg (0.009 mmol, 0.01 eq.) of dibutyltin dilaurate (DBTL) were added as catalyst and the mixture was heated to 70° C. Desmodur W (0.589 g, 2.245 mmol, 2.50 eq.) was added in three portions of equal size over a period of 7 hours. Subsequently, 10 mg of 3-methyl-1-phenyl-2-phospholene 1-oxide (0.05 mmol, 0.05 eq.) were added and the mixture was stirred at 90° C. for a further 7 hours. The polymer formed was separated out by precipitation with 100 mL of n-pentane.

Yield: 5.9 g; 78%.

The data ascertained in the characterization of the polyurethane are compiled in the table below.

| Content of oxymethylene units | 39% by weight | |
|---|---|---|
| Content of polypropylene oxide units | 37% by weight | |
| Content of polyethylene oxide units | 18% by weight | |
| Content of Desmodur W units | 6% by weight | |
| Molecular weight Mₙ | 18 785 | g/mol |
| Polydispersity index | 2.3 | |
| Thermal breakdown | 190° C. | |
| Melting point | 90° C. | |
| Calorific value to DIN 51900 | 24 140 | kJ/kg |
| Ignition time | 8.3 | s |

### Comparative Example 4: Production of a Polyurethane Foam with an Oxymethylene Polyol

For production of a flexible foam, a metal can was initially charged with 9.95 g (4.700 mmol, 0.0142 eq.) of polyol-4 (random distribution of the structural units). Water, 0.33 g (18.000 mmol, 0.37 eq.), and 0.06 g of tin(II) octanoate (0.148 mmol, 1.48 10⁻⁴ eq.) were added. The mixture was stirred at a speed of 1400 rpm, and toluene 2,6-diisocyanate, 6.91 g (39.700 mmol, 0.079 eq.), was introduced. After a reaction time of 5 minutes, the full volume of the foam had been attained.

The data ascertained in the characterization of the polyurethane foam are compiled in the table below.

| Content of oxymethylene units | 6% by weight | |
|---|---|---|
| Content of polypropylene oxide units | 51% by weight | |
| Content of toluene 2,6-diisocyanate units | 40% by weight | |
| Calorific value to DIN 51900 | 27 030 | kJ/kg |
| Ignition time | 8.43 | s |

### Oxymethylene Comparative Example 5: Preparation of a Polyurethane with a Polyol with No Formaldehyde Content

Under protective gas (argon), 3 g (0.375 mmol, 1 eq.) of polyol-3 were dissolved in 10 mL of absolute 1,2-dichlorobenzene. 3 mg (0.004 mmol, 0.01 eq.) of dibutyltin dilaurate (DBTL) were added as catalyst and the mixture was heated to 80° C. Toluene 2,4-diisocyanate (0.098 g, 0.563 mmol, 1.48 eq.) was added in three portions of equal size over a period of 6 hours. The reaction mixture was stirred at a temperature of 80° C. with stirring for a further 10 h and then the polymer formed was freed of the solvent by concentrating under reduced pressure (10⁻² mbar) at a temperature of 110° C.

Yield: 3.0 g; 97%.

The data ascertained in the characterization of the polyurethane are compiled in the table below.

| Content of oxymethylene units | 0% by weight | |
|---|---|---|
| Content of polypropylene oxide units | 97% by weight | |
| Content of polyethylene oxide units | 0% by weight | |
| Content of toluene 2,4-diisocyanate units | 3% by weight | |
| Molecular weight Mₙ | 113 100 | g/mol |
| Polydispersity index | 1.1 | |
| Thermal breakdown | 320° C. | |
| Melting point | — | |
| Enthalpy of fusion | 0.0 | J/g |
| Calorific value to DIN 51900 | 28 290 | kJ/kg |
| Ignition time | 1.4 | s |

### Comparative Example 6: Preparation of a Polyurethane with Addition of Melamine

Under protective gas (argon), 1.722 g (0.215 mmol, 1 eq.) of polyol-3 were dissolved in 10 mL of absolute 1,2-dichlorobenzene. 1 mg (0.002 mmol, 0.01 eq.) of dibutyltin dilaurate (DBTL) was added as catalyst. 0.675 g (5.336 mmol, 11 eq.) of melamine in the form of powder were added to this mixture, and the batch was heated to 80° C. Toluene 2,4-diisocyanate (1.447 g, 8.318 mmol, 17.98 eq.) was added in three portions of equal size over a period of 6 hours. The reaction mixture was stirred at a temperature of 80° C. with stirring for a further 10 h.

No polyurethane within the scope of patent specification EP 0 004 618 A1 was obtained.

### Comparative Example 7: Preparation of a Polyurethane with Addition of Paraformaldehyde

Under protective gas (argon), 20.000 g (2.500 mmol, 1 eq.) of polyol-3 were dissolved in 15 mL of absolute 1,2-dichlorobenzene. 16 mg (0.025 mmol, 0.01 eq.) of dibutyltin dilaurate (DBTL) were added as catalyst. 5.800 g (14.500 mmol, 5.8 eq.) of paraformaldehyde (molecular mass of 400 g/mol) were added to this mixture, and the batch was heated to 80° C. Toluene 2,4-diisocyanate (2.530 g, 14.527 mmol, 5.8 eq.) was added in three portions of equal size over a period of 6 hours. The reaction mixture was stirred at a temperature of 80° C. with stirring for a further 10 h and then the polymer formed was separated out by precipitation with n-pentane.

Yield: 28.1 g; 97%.

The polyurethane obtained in this way had low thermal stability and evolved significant amounts of gas even at 40° C. The escaping gases were identified as formaldehyde by means of coupled mass spectroscopy. Within the temperature range of 40° C.−150° C., a loss of weight from the polyurethane of 15% by weight was measured.

### Comparative Example 8: Production of a Polyurethane Foam with a Polyol

For production of a flexible foam, a metal can was initially charged with 10.0 g (13.7 mmol, 0.0412 eq.) of polyol-5 (Arcot 1110). Water, 0.57 g (3.2 mmol, 0.06 eq.), and 0.05 g of tin(II) octanoate (0.124 mmol, 1.24 10⁻⁴ eq.) were added. The mixture was stirred at a speed of 1400 rpm, and toluene 2,6-diisocyanate, 14.6 g (83.9 mmol, 0.17 eq.), was introduced. After a reaction time of 5 minutes, the full volume of the foam had been attained.

The data ascertained in the characterization of the polyurethane foam are compiled in the table below.

| Content of oxymethylene units | 0% by weight | |
|---|---|---|
| Content of polypropylene oxide units | 51% by weight | |
| Content of toluene 2,6-diisocyanate units | 40% by weight | |
| Calorific value to DIN 51900 | 27 920 | kJ/kg |
| Ignition time | 3.48 | s |

### Comparison

The table below shows a comparison of the results for the inventive polyurethanes from Examples 1 to 3 and comparative examples 4 to 7.

| | | Content | | | |
|---|---|---|---|---|---|
| | | of oxy- | | | |
| | | methylene | Breakdown | Calorific | Ignition |
| | Polyol/ | units [% | temperature | value | time |
| Example | additive | by wt.] | [° C.] | [kJ/kg] | [s] |
| 1 | Polyol-1/- | 41 | 220 | 23 527 | 6.6 |
| 2 | Polyol-2/- | 41 | 211 | 23 930 | 12.5 |
| 3 | Polyol-2/- | 39 | 190 | 24 140 | 8.3 |
| 4 | Polyol-4/ - | 6 | n.d. | 27 030 | 8.7 |
| (comp.) | | | | | |
| 5 | Polyol-3/- | 0 | 320 | 28 290 | 1.4 |
| (comp.) | | | | | |
| 6 | Polyol-3/ | 0 | No PU obtained | | |
| (comp.) | melamine | | | | |
| 7 | Polyol-4/ | 20 | <40 | Release of gaseous | |
| (comp.) | PFA | | | formaldehyde | |
| 8 | Polyol-5/- | 0 | n.d. | 27 920 | 3.48 |
| (comp.) | | | | | |

PFA paraformaldehyde; n.d. not determined

A comparison of Examples 1 to 3 with comparative example 5 demonstrates that the calorific value of the inventive polyurethanes (examples 1 to 3) is distinctly reduced compared to conventional polyurethanes (comparative example 5), while the ignition time for the inventive polyurethanes (examples 1 to 3, ignition time ≥8.3 s) is distinctly prolonged compared to conventional polyurethanes (comparative example 5). By contrast, on addition of melamine to lower the calorific value, no polyurethane was obtained (comparative example 6). On use of a mixture of a polyether polyol and paraformaldehyde, the polyurethane obtained broke down even at low temperatures of 40° C. with release of gaseous formaldehyde (comparative example 7). The inventive polyurethanes thus have particularly advantageous fire characteristics.

1. A process for preparing a polyurethane polymer, comprising reacting a polyol component with a polyisocyanate component, wherein:
the polyol component comprises an oxymethylene polyol,
and
the quantitative ratio of the polyol component to the polyisocyanate component is chosen such that the polyurethane polymer obtained by the reaction has a content of oxymethylene groups originating from the oxymethylene polyol of ≥11% by weight to ≤50% by weight, and the content of oxymethylene groups originating from the oxymethylene polyol has been determined by means of proton resonance spectroscopy.

2. The process as claimed in claim 1, wherein the polyol component comprises an oxymethylene polyol A) and/or B) obtainable by:
(1) reacting formaldehyde with a starter compound having at least 2 Zerewitinoff-active hydrogen atoms and comonomers in the presence of a catalyst to form oxymethylene polyol A);
and/or
(2) reacting an oligomeric formaldehyde precursor with a starter compound having at least 2 Zerewitinoff-active hydrogen atoms in the presence of a catalyst to form oxymethylene polylol B).

3. The process as claimed in claim 1, wherein the oxymethylene polyol has a number-average molecular weight of <4500 g/mol, and wherein the number-average molecular weight has been determined by means of gel permeation chromatography (GPC).

4. The process as claimed in claim 1, wherein said oxymethylene polyol is prepared from at least one starter compound comprising at least one of a polyether polyol, a polyester polyol, a polyetherester polyol, a polyethercarbonate polyol, a polycarbonate polyol and a polyacrylate polyol.

5. The process as claimed in claim 1, wherein the average hydroxyl functionality of the polyol component is ≥1.8.

6. The process as claimed in claim 1, wherein the polyisocyanate component comprises an at least trifunctional polyisocyanate.

7. The process as claimed in claim 1, wherein the reaction is conducted at an NCO index of ≥90 to ≤200.

8. The process as claimed in claim 1, wherein the polyol component comprises at least one further polyol comprising at least one of a polyether polyol, a polyester polyol, a polyetherester polyol, a polyethercarbonate polyol, a polycarbonate polyol and a polyacrylate polyol.

9. The process as claimed in claim 1, wherein in the preparation of the oxymethylene polyol, the polymerization is effected in the presence of a further comonomer.

10. The process as claimed in claim 1, wherein the reaction of said polyol component with said polyisocyanate component is conducted in the absence of a flame retardant.

11. A polyurethane polymer comprising the reaction product of
a polyol component with a polyisocyanate component wherein the polyol component comprises an oxymethylene polyol,
and
the quantitive ratio of the polyol component to the polyisocyanate component is chosen such that the resultant polyurethane polyol has a content of oxymethylene groups originating from the oxymethylene polyol of ≥11% by weight to ≤50% by weight, in which the content of the oxymethylene groups originating from the oxymethylene polyol has been determined by proton resonance spectroscopy.

12. The polyurethane polymer as claimed in claim 11, having a content of oxymethylene groups of of ≥11% by weight to ≤45% by weight, and the content of oxymethylene groups originating from tire oxymethylene polyol has been determined by means of proton resonance spectroscopy.

13. The polyurethane polymer as claimed in claim 11, having a calorific value to DIN 51900 of ≤26 000 kJ/kg.

14. The polyurethane polymer as claimed in claim 11, in which the polyurethane polymer is prepared by reacting a polyol component with a polyisocyanate component in the absence of flame retardant.

15. An insulation material comprising the a polyurethane polymer as claimed in claim 11.

16. The process as claimed in claim 1, wherein the polyurethane polymer obtained has a content of oxymethylene groups originating from the oxymethylene polyol of ≥11% by weight to ≤45% by weight.

17. The process as claimed in claim 1, wherein the average hydroxyl functionality of the polyol component is ≥1.9.

18. The process as claimed in claim 1, wherein the average hydroxyl functionality of the polyol component is ≥2.0.

19. The polyurethane polymer as claimed in claim 12 having a content of oxymethylene groups of ≥11% by weight to ≤45% by weight.
